(19) United States
(12) Patent Application Publication
(10) Pub. No.: US 2003/0133633 A1
(43) Pub. Date: Jul. 17, 2003

(54) Dynamic pressure type fluid bearing device and method of manufacturing the fluid bearing device

(76) Inventor: Junichi Nakamura, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 10/111,593

(22) PCT Filed: Jun. 21, 2001
(86) PCT No.: PCT/JP01/05333

(30) Foreign Application Priority Data
Aug. 28, 2000 (JP) 2000-256921

(51) Int. Cl. F16C 32/06

(52) U.S. Cl. 384/107; 384/119

(57) ABSTRACT

A hydrodynamic bearing unit and a manufacturing method therefor that reduce manufacturing costs and prevent leakage of lubricating oil are provided. The bearing unit includes a shaft, a sleeve which is rotatably mounted to the shaft and which forms a radial bearing in cooperation with the shaft, and a pair of seal members which are fixed to the shaft, which form respective thrust bearing parts in cooperation with the sleeve, and which seal lubricating oil circulating in the bearing unit. The shaft has a large-diameter part functioning as one of the seal members. The other seal member is fixed to the shaft by press-fitting.

### TECHNICAL FIELD

The present invention relates to a hydrodynamic bearing unit used in a magnetic disc drive or the like and a method of manufacturing the unit.

### BACKGROUND ART

A conventional hydrodynamic bearing unit includes a sealing member separate from a shaft. Lubricating oil is injected by dipping the bearing unit entirely into the lubricating oil in a vacuum and then restoring the bearing unit to atmospheric pressure. Alternatively, the lubricating oil is dropped into a bearing in assembling the bearing unit. The conventional hydrodynamic bearing unit and a method of manufacturing the unit will be explained.

FIG. 12 is a sectional view of an essential part of the conventional dynamic bearing unit. The bearing unit includes shaft 101 implanted in a base (not shown) and a cylindrical sleeve 103 rotatably mounted to shaft 101. Both ends of sleeve 103 have respective inside diameters larger than that of a center part of sleeve 103. Opposed faces of shaft 101 and sleeve 103 cooperatively form a radial bearing. The bearing unit further includes a first seal member 102 and a second seal member 104 disposed at respective lower and upper parts of the bearing unit. Faces of first seal member 102 and sleeve 103 facing each other in a longitudinal direction of shaft 101 cooperatively form a thrust bearing. And faces of second seal member 104 and sleeve 103 facing each other in the longitudinal direction of shaft 101 cooperatively form another thrust bearing. Faces of first seal member 102 and sleeve 103 facing each other in a radial direction of shaft 101 cooperatively form V-shaped capillary seal 106 for sealing the lubricating oil. And faces of second seal member 104 and sleeve 103 facing each other in the radial direction of shaft 101 cooperatively form another V-shaped capillary seal 106 for sealing the lubricating oil.

First seal member 102 is fixed to shaft 101 by press fitting with a jig (not shown) at a desired mounting height. Then, sleeve 103 is introduced to shaft 101, and subsequently, second seal member 104 is fixed to shaft 101 by press fitting with a jig to provide the bearing unit.

The bearing unit is dipped entirely into the lubricating oil under vacuum and then restored to the atmospheric pressure, and thereby the lubricating oil is injected by a difference in pressure. Alternatively, the bearing unit has the lubricating oil dropped therein when being assembled.

The above-described bearing unit, since including the seal members separate from the shaft, is subject to assembly errors in the many assembly steps, thus precluding cost reduction.

### DISCLOSURE OF THE INVENTION

A hydrodynamic bearing unit includes a shaft including a large-diameter part, a sleeve mounted rotatably to the shaft, and a seal member forming a thrust bearing in cooperation with the sleeve. The large-diameter part and the sleeve cooperatively form another thrust bearing. The bearing unit is assembled without error in but a few assembly steps.

A jig including an annular elastic member seals an oil seal defined by the sleeve and the seal member or the large-diameter part, and lubricating oil is injected into the bearing unit by vacuum suction. The jig is fixed to the shaft by a magnet, a screw or engagement between an engaging projection and a recess. Thus, only one end of the bearing unit is required to be cleaned after the injection of the lubricating oil. Further, an opening of one capillary seal can be sealed easily, and the jig can be detached easily after the injection of the lubricating oil.

### BRIEF DESCRIPTION OF THE DRAWINGS

FIG. 1 is a sectional view of an essential part of a hydrodynamic bearing unit in accordance with a first exemplary embodiment of the present invention.

FIG. 2 is a sectional of an essential part of a hydrodynamic bearing unit in accordance with the first embodiment.

FIG. 3 is a sectional view of an essential part of a hydrodynamic bearing unit in accordance with the first embodiment.

FIG. 4 is a sectional view of an essential part of a hydrodynamic bearing unit having a jig mounted thereon in accordance with a second exemplary embodiment of the present invention.

FIG. 5 is a sectional view of an essential part of a hydrodynamic bearing unit having a jig mounted thereon in accordance with the second embodiment.

FIG. 6 is a sectional view of an essential part of a hydrodynamic bearing unit having a jig mounted thereon in accordance with the second embodiment.

FIG. 7 is a sectional view of an essential part of a hydrodynamic bearing unit in accordance with a third exemplary embodiment of the present invention.

FIG. 8 is an enlarged sectional view of the essential part of the hydrodynamic bearing unit in accordance with the third embodiment.

FIG. 9 is a sectional view of an essential part of the hydrodynamic bearing unit in accordance with the third embodiment.

FIG. 10 is an enlarged sectional view of the essential part of the hydrodynamic bearing unit in accordance with the third embodiment.

FIG. 11 is a sectional view of an essential part of a magnetic disc drive in accordance with a fourth exemplary embodiment of the present invention.

FIG. 12 is a sectional view of an essential part of a conventional hydrodynamic bearing unit.

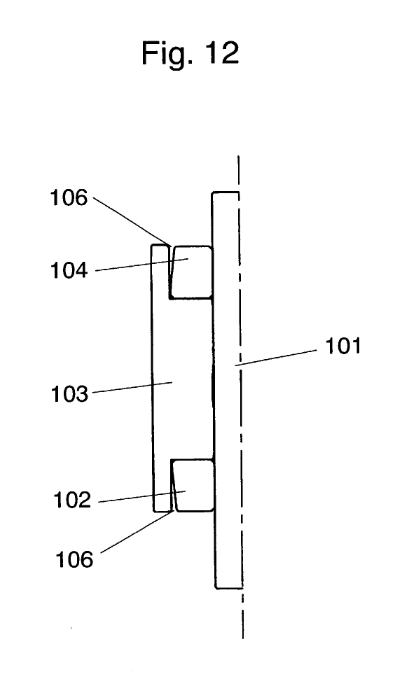

### DESCRIPTION OF THE PREFERRED EMBODIMENTS

(Exemplary Embodiment 1)

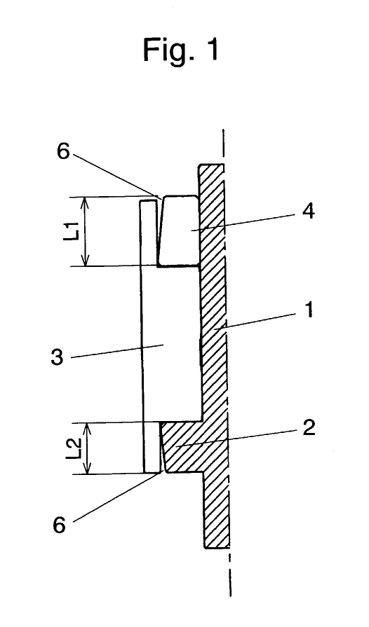

Referring to FIGS. 1-3, a first exemplary embodiment of the present invention will be described. FIGS. 1-3 are sectional views illustrating an essential part of a hydrodynamic bearing unit in accordance with the first embodiment of this invention.

As shown in FIG. 1, the bearing unit includes a shaft 1 having a large-diameter part 2 at a lower part thereof, cylindrical sleeve 3 rotatably mounted to shaft 1, and seal member 4 disposed at an upper part of the bearing unit. Sleeve 3 has both ends thereof having respective inside diameters larger than a diameter of a center part thereof. Respective opposing faces of shaft 1 and sleeve 3 cooperatively form a radial bearing. The bearing unit of the embodiment has a simple structure since it utilizes the seal member and the shaft corresponding to first seal member 102 and shaft 101 unitarily formed in the conventional bearing unit. Shaft 1 and sleeve 3 cooperatively form a radial bearing. Large-diameter part 2 of shaft 1, seal member 4 and sleeve 3 cooperatively form a thrust bearing. In other words, the thrust bearing includes a first thrust bearing part cooperatively formed by seal member 4 and sleeve 3 and a second thrust bearing part cooperatively formed by large-diameter part 2 and sleeve 3. Seal member 4 is fixed to shaft 1 by, for example, press fitting or shrinkage fitting.

If an axial length L1 of seal member 4 is longer than an axial length L2 of large-diameter part 2 in a direction parallel with an axial direction of rotation, a surface of a disk is prevented from being contaminated due to leaking or splashing lubricating oil, even in cases where the lubricating oil undergoes thermal expansion or has air penetrated thereinto.

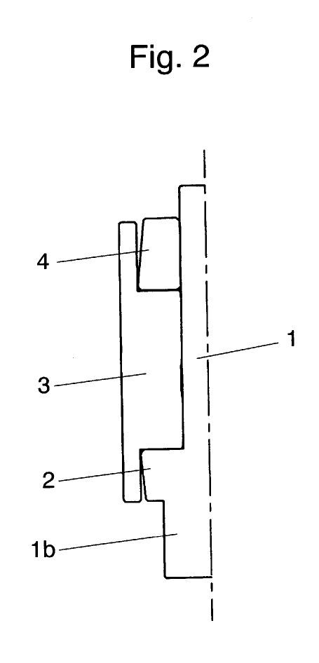

In machining or grinding of an outer peripheral surface of shaft 1, a small-diameter part of shaft 1 and top and bottom faces of large-diameter part 2 undergo the grinding simultaneously. This arrangement allows a lower end part 1b of shaft 1 to be large in diameter as shown in FIG. 2. In other words, since it is not necessary for a first seal member to be fixed to the shaft by press-fitting as was the case with the conventional bearing unit. Therefore, regardless of the inside diameter of sleeve 3, shaft 1 can include the lower end part 1b having the larger diameter than other of the part 1b of shaft 1. This allows shaft 1 to be strong mechanically.

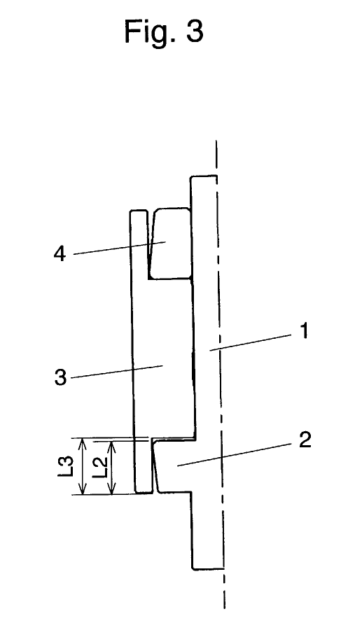

As shown in FIG. 3, a length L3 from a bottom end of sleeve 3 to the face of sleeve 3 that faces the top face of large-diameter part 2 is longer than axial length L2 of large-diameter part 2. Second seal member 4 is press-fitted until seal member 4 contacts with sleeve 3 while the bottom end of sleeve 3 is aligned flush with the bottom of large-diameter part 2. This provides the thrust bearing with a desired axial clearance (L3-L2).

According to the present embodiment described above, shaft 1 and the unitarily formed first seal member allow the bearing unit to have a simple structure and to be assembled accurately and easily. This reduces the number of components as well as cost.

(Exemplary Embodiment 2)

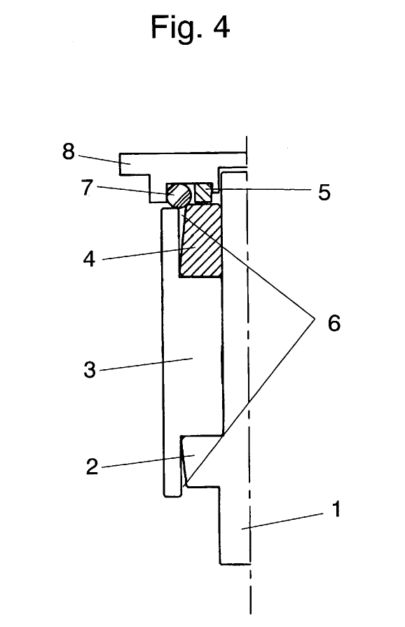

A method of manufacturing a hydrodynamic bearing unit in accordance with a second exemplary embodiment of the present invention will be described with reference to FIGS. 4-6. The hydrodynamic bearing unit of the present embodiment has a similar basic structure to that of the foregoing first exemplary embodiment. Thus, similar elements are denoted by the same reference numerals, and are not described in detail.

FIG. 4 is a sectional view of an essential part of the bearing unit having a jig mounted thereon for injection of lubricating oil. Seal member 4 is made of a magnetic material. Attractive force between seal member 4 and an annular magnet 5 provided on disc-like jig 8 presses annular elastic member 7, which is preferably made of rubber, onto jig 8 against an opening portion of capillary seal 6 for sealing the lubricating oil, thereby sealing a top part of the bearing unit.

The bearing unit has an upper part sealed and a lower part dipped in a vessel containing the lubricating oil. The unit is held in a vacuum and then is restored to atmospheric pressure. This injects the lubricating oil into the bearing unit by a change in air pressure as if the oil is drawn into the bearing unit.

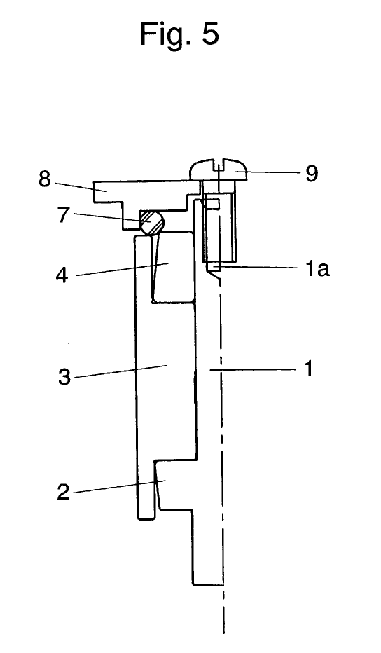

Instead of magnet 5, screw 9 and a screw hole 1a of shaft 1 may fix jig 8 to the bearing unit, as shown in FIG. 5.

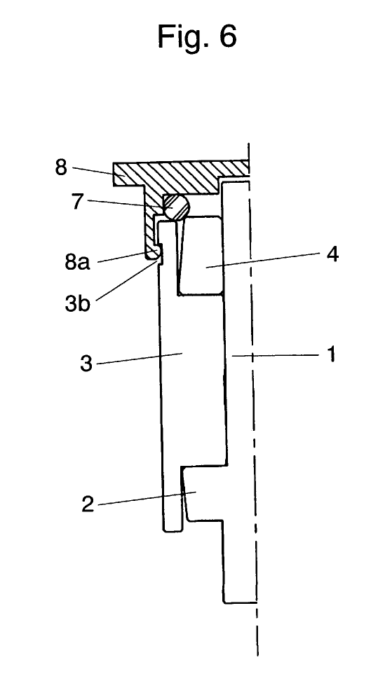

Alternatively, as shown in FIG. 6, jig 8, which is preferably made of resin, may be provided with a leg and a projection 8a at a tip of the leg. Projection 8a may be engaged in a recess 3b provided at an upper part of an outer peripheral surface of sleeve 3 by an elastic deformation of jig 8. Elastic member 7 is thus pressed toward the opening of capillary seal 6, thereby sealing seal 6.

According to this embodiment, one of the top opening and a bottom opening of the bearing unit is sealed by the jig, and only the other opening of the bearing unit is dipped into the lubricating oil. Thereby, all that is required to be cleaned is the opening into which the lubricating oil is injected. This improves cleaning operability, and reduces cost.

(Exemplary Embodiment 3)

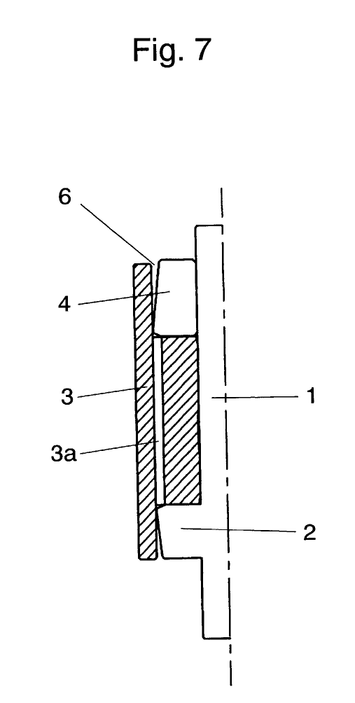

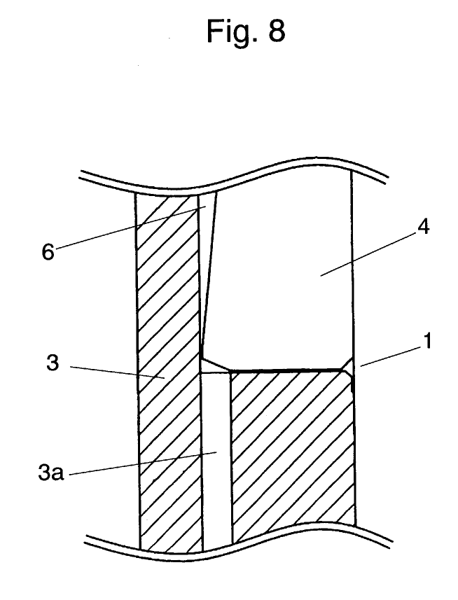

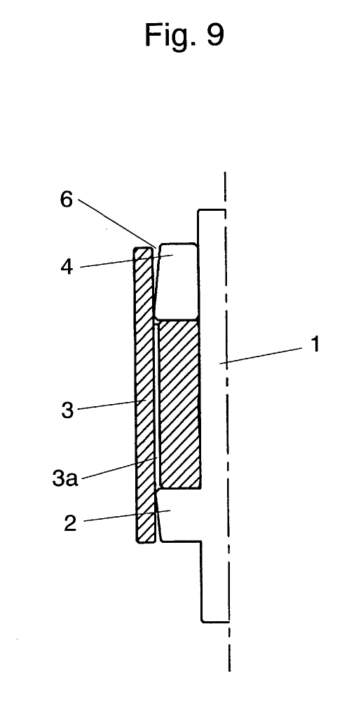

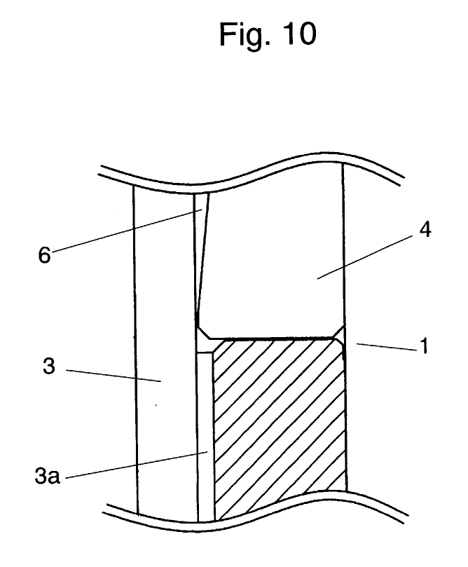

Referring to FIGS. 7-10, a third exemplary embodiment will be described. FIG. 7 and FIG. 9 are sectional views illustrating an essential part of a hydrodynamic bearing unit in accordance with the present embodiment. FIG. 8 and FIG. 10 are enlarged sectional views illustrating the essential parts of FIGS. 7 and 9, respectively. Elements similar to those described in the foregoing embodiments are denoted by the same reference numerals.

As shown in FIG. 7 and FIG. 8, sleeve 3 of the present embodiment includes plural through-holes 3a arranged concentrically with respective capillary seals 6 provided at top and bottom openings of the bearing unit. Large-diameter part 2 and seal member 4 have respective corners facing through-holes 3a, and these corners are chamfered more than two of the other corners.

As shown in FIG. 9 and FIG. 10, sleeve 3 has a corner facing capillary seal 6 for sealing lubricating oil, and this corner of sleeve 3 may be chamfered so that an opening of through-hole 3a of sleeve 3 may be positioned below a thrust bearing part.

This enables an atmospheric pressure to be easily applied to the lubricating oil. As a result, even if the lubricating oil moves unevenly between the top and bottom openings of the bearing unit due to external shock or vibration, the oil is directed back promptly in the bearing unit. This prevents the lubricating oil from leaking.

(Exemplary Embodiment 4)

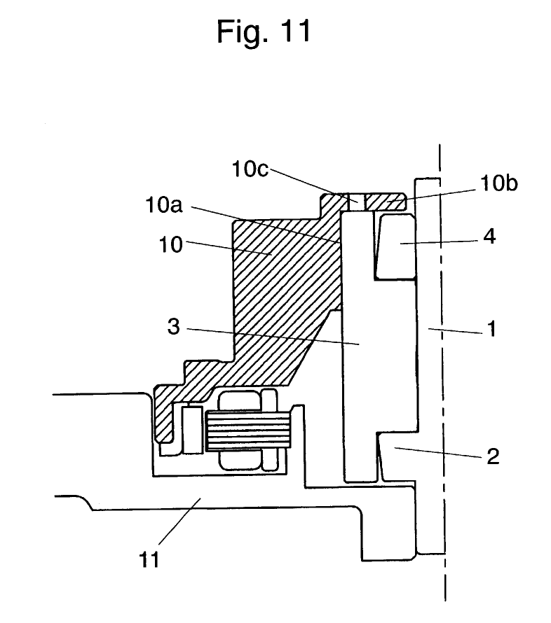

A fourth exemplary embodiment will be described with reference to FIG. 11. FIG. 11 is a sectional view of an essential part of a magnetic disc drive in accordance with the fourth embodiment of the present invention. Elements similar to those described in the foregoing embodiments are denoted by the same reference numerals. Shaft 1 is implanted in a base 11, and sleeve 3 has, at its outer periphery, a substantially-cylindrical motor hub 10 fixed by engagement on the sleeve 3. Motor hub 10 has a central hole 10a, and a flange 10b extending radially inwardly above central hole 10a. Flange 10b covers sleeve 3 and an end of second seal member 4, and is provided with plural through-holes 10c reaching an end of sleeve 3. Thus, when components are to be replaced, motor hub 10 can be detached from the bearing unit by inserting a pin into through-hole 10c of flange 10b to press the end of sleeve 3. This facilitates the replacement of the components. In addition, flange 10b can seal the bearing unit.

### INDUSTRIAL APPLICABILITY

The present invention relates to a hydrodynamic bearing unit for, for example, a magnetic disc drive, and to a method of manufacturing the unit.

The bearing unit can be assembled without error in a few process steps.

According to the manufacturing method, only one of the end portions of the bearing unit is required to be cleaned after having the lubricating oil injected thereinto. Further, an opening of one of capillary seals can be sealed easily, and a jig can be detached easily after the injection of the lubricating oil.

1 Shaft

1a Screw Hole

2 First Seal Member

3 Sleeve

3a Through-Hole

3b Recess

4 Second Seal Member

5 Magnet

6 Capillary Seal

7 Elastic Body

8 Jig

8a Projection

9 Screw

10 Motor Hub

10a Center Hole

10b Flange

10c Through-Hole

What is claimed is:

1. A hydrodynamic bearing unit comprising:
a shaft having a large-diameter part;
a sleeve mounted to said shaft relatively rotatably; and
a seal member fixed to said shaft and forming a first thrust bearing in cooperation with said sleeve,
wherein said large-diameter part and said sleeve cooperatively form a second thrust bearing.

2. The hydrodynamic bearing unit of claim 1, wherein a length of said large-diameter part in a direction of a rotation axis is greater than a length of said seal member in the direction.

3. The hydrodynamic bearing unit of claim 1,
wherein said shaft has first and second parts at respective sides of said large-diameter part in a direction of a rotation axis, said first part having a smaller diameter than said second part, and
wherein said sleeve is mounted to said first part of said shaft.

4. The hydrodynamic bearing unit of claim 1, wherein a distance between a face of said sleeve that forms said second thrust bearing and an end of said sleeve near said large-diameter part is equal to a sum of a length of said large-diameter part in a direction of a rotation axis, a clearance of said first thrust bearing, and a clearance of said second thrust bearing.

5. The hydrodynamic bearing unit of claim 1, wherein said sleeve has a through-hole formed therein between respective outer peripheries of said first and second thrust bearings.

6. The hydrodynamic bearing unit of claim 5, wherein said through-hole extending in a direction of a rotation axis.

7. The hydrodynamic bearing unit of claim 5,
wherein a first opening of said through-hole opening toward said seal member and said seal member form a larger space than a clearance of said first thrust bearing, and
wherein a second opening of said through-hole opening toward said large-diameter part and said large-diameter part form a larger space than a clearance of said second thrust bearing.

8. The hydrodynamic bearing unit of claim 7,
wherein a corner of said seal member that is located toward said through-hole is a chamfered corner, and
wherein a corner of said large-diameter part that is located toward said through-hole is a chamfered corner.

9. The hydrodynamic bearing unit of claim 7, wherein said sleeve is chamfered at a location near said through-hole.

10. The hydrodynamic bearing unit of claim 1, wherein at least one of said seal member and said large-diameter part is made of magnetic material.

11. The hydrodynamic bearing unit of claim 1, further comprising:
a motor hub mounted to an outer periphery of said sleeve, said motor hub including a flange covering an end of said sleeve,
wherein said flange has a through-hole formed therein at a position opposite to said end of said sleeve.

12. A method of manufacturing a hydrodynamic bearing unit including a shaft, a sleeve mounted relatively rotatably to the shaft, and a seal member fixed to the shaft, said method comprising:
inserting the shaft into the sleeve; and
then fixing the seal member to the shaft;
wherein the shaft includes a large-diameter part forming a thrust bearing in cooperation with the sleeve.

13. The method of claim 12, wherein said fixing of the seal member to the shaft comprises fixing the seal member to the shaft by press-fitting.

14. The method of claim 12, further comprising:
grinding an outer peripheral surface of the shaft and a face of the large-diameter part simultaneously, the face of the large-diameter part being non-parallel with a rotation axis of the sleeve.

15. The method of claim 12,
wherein said inserting of the shaft into the sleeve comprises aligning said end of the sleeve to be flush with a face of the large-diameter part that is opposite to a face of the large-diameter part that forms the thrust bearing,
wherein said press-fixing of the seal member to the shaft comprises pressing the sleeve with the seal member, and
wherein a length between a face of the sleeve forming the thrust bearing and an end of the sleeve is greater than a length of the large-diameter part in a direction of a rotation axis.

16. The method of claim 12, further comprising:
providing a jig including a magnet and an annular elastic member;
attracting the seal member with the magnet after said fixing of the seal member to the shaft; and
sealing a first opening defined by the sleeve and the seal member with the elastic member,
wherein the seal member is made of magnetic material.

17. The method of claim 16, further comprising:
dipping a second opening, defined by the large-diameter part and the sleeve, into lubricating oil under an environmental pressure of a first air pressure; and
changing the environmental pressure to a second air pressure higher than the first air pressure while the second opening is dipped in the lubricating oil.

18. The method of claim 12, further comprising:
providing a jig including a magnet and an annular elastic member;
attracting the large-diameter part with the magnet after said fixing of the seal member to the shaft; and
sealing a first opening defined by the sleeve and the large-diameter part with the elastic member;
wherein the large-diameter part is made of magnetic material.

19. The method of claim 18, further comprising:
dipping a second opening, defined by the seal member and the sleeve, into lubricating oil under an environmental pressure of a first air pressure; and
changing the environmental pressure to a second air pressure higher than the first air pressure while the second opening is dipped in the lubricating oil.

20. The method of claim 12, further comprising:
providing a jig including an annular elastic member, the jig having a hole formed therein;
fixing the jig to an end of the shaft with the screw through the hole after said fixing of the seal member to the shaft, the end being near the seal member; and
sealing a first opening, defined by the sleeve and the seal member, with the elastic member.

21. The method of claim 20, further comprising:
dipping a second opening, defined by the large-diameter part and the sleeve, into lubricating oil under an environmental pressure of a first air pressure; and
changing the environmental pressure to a second air pressure higher than the first air pressure while the second opening is dipped in the lubricating oil.

22. The method of claim 12, further comprising:
providing a jig including an annular elastic member, the jig having a hole formed therein;
fixing the jig to an end of a shaft with a screw through the hole after said fixing of the seal member to the shaft, the end being near the large-diameter part; and
sealing a first opening, defined by the sleeve and the large-diameter part, with the elastic member.

23. The method of claim 22, further comprising:
dipping a second opening, defined by the sleeve and the seal member, into lubricating oil under an environmental pressure of a first air pressure; and
changing the environmental pressure to a second air pressure higher than the first air pressure while the second opening is dipped in the lubricating oil.

24. The method of claim 12, further comprising:
providing a jig including an annular elastic member and a leg having an engaging projection at a tip thereof;
engaging the engaging projection into a recess provided at an outer periphery of the sleeve; and
sealing a first opening, defined by the sleeve and one of the large-diameter part and the large-diameter part, with the elastic member.

25. The method of claim 24, further comprising:
dipping a second opening, defined by the sleeve, that is opposite to the first opening, in lubricating oil under an environmental pressure of a first air pressure; and
changing the environmental pressure to a second air pressure higher than the first air pressure while the second opening is dipped in the lubricating oil.
